(19) United States
(12) Patent Application Publication
(10) Pub. No.: US 2018/0329333 A1
(43) Pub. Date: Nov. 15, 2018

(54) CURABLE LIQUID DEVELOPER AND METHOD FOR MANUFACTURING CURABLE LIQUID DEVELOPER

(71) Applicant: CANON KABUSHIKI KAISHA, Tokyo (JP)

(72) Inventors: Yuzo Tokunaga, Chiba-shi (JP); Naohiko Tsuchida, Abiko-shi (JP); Akifumi Matsubara, Narashino-shi (JP); Yasutaka Akashi, Yokohama-shi (JP); Junji Ito, Hiratsuka-shi (JP); Yasuhiro Aichi, Tokyo (JP)

(21) Appl. No.: 15/969,103

(22) Filed: May 2, 2018

(30) Foreign Application Priority Data
May 11, 2017 (JP) 2017-094850
Feb. 5, 2018 (JP) 2018-018692

(51) Int. Cl. G03G 9/12; G03G 9/09; G03G 9/087; G03G 9/08; G03G 9/13; G03G 9/125

(52) U.S. Cl. CPC G03G 9/122; G03G 9/0918; G03G 9/125; G03G 9/0804; G03G 9/132; G03G 9/08755

(57) ABSTRACT

A curable liquid developer including: a toner particle containing a binder resin and a pigment; a toner particle dispersing agent; and a cationically polymerizable liquid monomer that does not dissolve the binder resin, wherein the pigment contains a copper phthalocyanine derivative represented by formula (1) below;

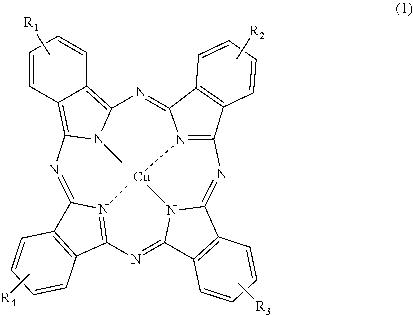

in formula (1), each of R₁, R₂, R₃ and R₄ individually represents a hydrogen atom or a substituent derived from an amine compound, and at least one of R₁, R₂, R₃ and R₄ represents a substituent derived from an amine compound.

### BACKGROUND OF THE INVENTION

### Field of the Invention

The present invention relates to a liquid developer for use in image forming apparatuses using electrophotographic systems, and to a method for manufacturing the liquid developer.

### Description of the Related Art

In recent years, attention in the field of image forming apparatuses using electrophotographic systems has focused on high-quality, high-speed digital printing devices based on wet developing systems, which are excellent for high-speed image formation.

A wet developing system uses a liquid developer comprising a toner particle dispersed in a carrier liquid. The toner particle in this case can be finer than in a developer using a dry developing system. Consequently, wet developing systems have better dot image reproducibility and gradation reproducibility than dry developing systems.

Conventionally, liquid developers are known that use an dielectric liquid such as a hydrocarbon-based organic solvent or silicone oil as a carrier liquid, in which a colored resin particle is dispersed as a toner particle. However, a significant reduction in image quality may result if the dielectric liquid remains on a recording medium such as paper or plastic film, and it has thus been necessary to remove the dielectric liquid. The common method of removal is by applying thermal energy to volatilize the dielectric liquid. However, this method is not necessarily desirable from an environmental or energy conservation standpoint, since organic solvent vapor may be released outside the apparatus, and large amounts of energy may be required.

A method of curing the dielectric liquid by a photopolymerization reaction has been proposed for solving this problem. Such a curable liquid developer uses a monomer or oligomer having a reactive functional group as the dielectric liquid, with a photopolymerization initiator dissolved therein.

Japanese Patent Application Laid-open No. 2015-127812 discloses, as a curable liquid developer, a liquid developer using a cationically polymerizable monomer that provides greater electrical insulation.

Moreover, copper phthalocyanine pigments with excellent color gamut and robustness are commonly used as blue or green colorants in the toner particle of full-color developers.

### SUMMARY OF THE INVENTION

However, when a copper phthalocyanine pigment is used as a colorant in a toner particle, a so-called dark polymerization reaction may occur, in which the photopolymerization initiator initiates a reaction without any light energy being applied, and the carrier liquid is cured without undergoing a photopolymerization reaction.

Therefore, the present invention provides a curable liquid developer that is resistant to dark polymerization reactions even when it contains a copper phthalocyanine pigment, and a method for manufacturing this curable liquid developer.

The present invention relates to a curable liquid developer including: a toner particle containing a binder resin and a pigment; a toner particle dispersing agent; and a cationically polymerizable liquid monomer that does not dissolve the binder resin, wherein the pigment contains a copper phthalocyanine derivative represented by formula (1) below.

The present invention also provides a method for manufacturing a curable liquid developer including a toner particle containing a binder resin and a pigment, a toner particle dispersing agent, and a cationically polymerizable liquid monomer that does not dissolve the binder resin,

the method including:

preparing a pigment-dispersed solution containing the binder resin, the pigment, the toner particle dispersing agent and a solvent that dissolves the binder resin;

preparing a liquid mixture containing the pigment-dispersed solution and the cationically polymerizable liquid monomer; and

removing the solvent from the liquid mixture, wherein

the pigment contains a copper phthalocyanine derivative represented by formula (1) below.

Moreover, the present invention provides a method for manufacturing a curable liquid developer including a toner particle containing a binder resin and a pigment, a toner particle dispersing agent, and a cationically polymerizable liquid monomer that does not dissolve the binder resin,

the method including:

preparing a pigment-dispersed solution containing the binder resin, the pigment, the toner particle dispersing agent and a first solvent dissolving the binder resin;

preparing a first mixture containing the pigment-dispersed solution and a second solvent not dissolving the binder resin, the second solvent being other than the cationically polymerizable liquid monomer;

preparing a toner particle dispersion by removing the first solvent dissolving the binder resin from the first mixture, and

preparing a second mixture containing the toner particle dispersion and the cationically polymerizable liquid monomer, wherein

the pigment contains a copper phthalocyanine derivative represented by formula (1) below.

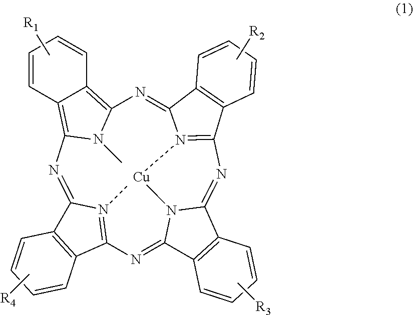

In formula (1), each of R₁, R₂, R₃ and R₄ individually represents a hydrogen atom or a substituent derived from an amine compound, and at least one of R₁, R₂, R₃ and R₄ represents a substituent derived from an amine compound.

Further features of the present invention will become apparent from the following description of exemplary embodiments.

### DESCRIPTION OF THE EMBODIMENTS

Unless otherwise specified, descriptions of numerical ranges such as “at least A and not more than B” or “A to B” in the present invention include the numbers at the upper and lower limits of the range.

The investigations of the inventors have shown that the dark polymerization reactions described above become a problem when a pigment comprising a copper phthalocyanine is contained as a colorant in a toner particle of a curable liquid developer comprising a cationically polymerizable liquid monomer having strong dielectric properties.

This is thought to be because acids and radicals are generated due to the catalytic effect of the copper phthalocyanine even when no light energy is supplied to the photopolymerization initiator, leading to a polymerization reaction of monomers.

By contrast, the photopolymerization initiation effect can be suppressed and dark polymerization reactions can be prevented by using a pigment containing a copper phthalocyanine derivative having a substituent derived from an amine compound, and causing the resulting acids to bind with the amine compound.

That is, the curable liquid developer (hereunder sometimes called simply the liquid developer) of the invention is a curable liquid developer including a toner particle containing a binder resin and a pigment, a toner particle dispersing agent, and a cationically polymerizable liquid monomer that does not dissolve the binder resin, wherein

the pigment contains a copper phthalocyanine derivative represented by formula (1) above.

Moreover, the method for manufacturing the curable liquid developer of the present invention is a method for manufacturing a curable liquid developer including a toner particle containing a binder resin and a pigment, a toner particle dispersing agent, and a cationically polymerizable liquid monomer that does not dissolve the binder resin,

the method including:

preparing a pigment-dispersed solution containing the binder resin, the pigment, the toner particle dispersing agent and a solvent dissolving the binder resin;

preparing a liquid mixture containing the pigment-dispersed solution and the cationically polymerizable liquid monomer; and

removing the solvent from the mixture, wherein

the pigment contains a copper phthalocyanine derivative represented by formula (1) above.

Furthermore, the method for manufacturing the curable liquid developer of the present invention is a method for manufacturing a curable liquid developer including a toner particle containing a binder resin and a pigment, a toner particle dispersing agent, and a cationically polymerizable liquid monomer that does not dissolve the binder resin,

the method including:

preparing a pigment-dispersed solution containing the binder resin, the pigment, the toner particle dispersing agent and a first solvent dissolving the binder resin;

preparing a first liquid mixture containing the pigment-dispersed solution and a second solvent not dissolving the binder resin, the second solvent being other than the cationically polymerizable liquid monomer;

preparing a toner particle dispersion by removing the first solvent dissolving the binder resin from the first liquid mixture; and

a step of preparing a second mixture containing the toner particle dispersion and the cationically polymerizable liquid monomer, wherein

the pigment contains a copper phthalocyanine derivative represented by formula (1) above.

The materials constituting the liquid developer are explained in detail below.

The curable liquid developer contains a toner particle.

The toner particle contains a binder resin and a pigment.

The pigment contains a copper phthalocyanine derivative represented by formula (1) below.

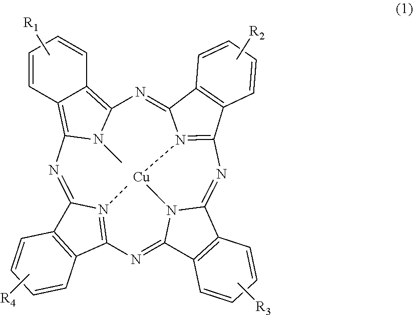

In the formula (1), each of R₁, R₂, R₃ and R₄ individually represents a hydrogen atom or a substituent derived from an amine compound, and at least one of R₁, R₂, R₃ and R₄ represents a substituent derived from an amine compound.

Examples of the substituent derived from an amine compound include the substituents of formulae (A), (B), (C), (D) and the like below.

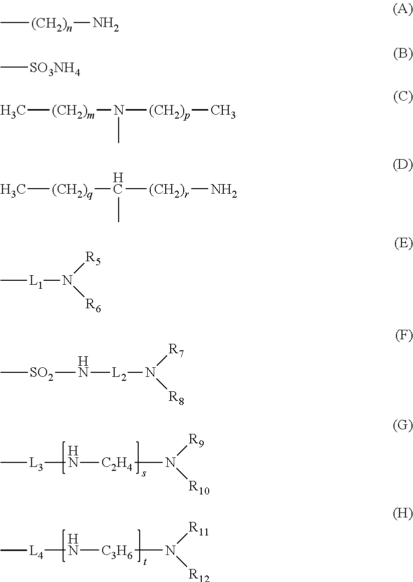

In formula (A), n is preferably an integer of at least 0 and not more than 10, and more preferably an integer of at least 0 and not more than 4.

In formula (C), preferably each of m and p is independently an integer of at least 0 and not more than 10, or more preferably an integer of at least 1 and not more than 4.

In formula (D), preferably each of q and r is independently an integer of at least 0 and not more than 10, or more preferably an integer of at least 1 and not more than 4.

In formulae (E), (F), (G) and (H), preferably each of L₁, L₂, L₃ and L₄ is independently a C₁₋₄ linear or branched saturated alkylene group, or more preferably a C₁₋₂ linear saturated alkylene group.

In formulae (E), (F), (G) and (H), preferably each of R₅, R₆, R₇, R₈, R₉, R₁₀, R₁₁ and R₁₂ is independently a hydrogen atom or C₁₋₄ linear or branched saturated alkyl group, or more preferably a hydrogen atom or C₁₋₂ linear saturated alkyl group.

In formulae (E), (F), (G) and (H), preferably each of s and t is independently an integer of at least 1 and not more than 5, or more preferably an integer of at least 1 and not more than 2.

The pigment containing a copper phthalocyanine derivative with an introduced substituent derived from an amine compound may be manufactured by the following methods.

For example, in one method a synthetic copper phthalocyanine obtained by reacting phthalic anhydride with a urea compound and metal copper is mixed with a copper phthalocyanine derivative having a substituent derived from an amine compound, and pulverized by a wet or dry process to obtain a pigment.

Alternatively, a copper phthalocyanine derivative having a substituent derived from an amine compound may be mixed by a wet or dry process with an unsubstituted commercial phthalocyanine pigment, such as C.I. Pigment Blue 15, C.I. Pigment Blue 15:2, C.I. Pigment Blue 15:3 or C.I. Pigment Blue 15:4 for example to obtain the pigment.

In this case, the mixing ratio of the unsubstituted phthalocyanine pigment and the copper phthalocyanine derivative having a substituent derived from an amine is preferably 50:1 to 1:1 by mass, or more preferably 20:1 to 5:1 by mass.

The content of the copper phthalocyanine derivative having a substituent derived from an amine in the pigment is preferably at least 1 mass % and not more than 50 mass %, or more preferably at least 5 mass % and not more than 15 mass %.

The content of the pigment is preferably at least 10 and not more than 100 mass parts, or more preferably at least 12 and not more than 50 mass parts per 100 mass parts of the binder resin.

The average introduced amount of the substituent derived from an amine compound in the copper phthalocyanine derivative having a substituent derived from an amine compound is preferably at least 0.5 and not more than 16.0, or more preferably at least 1.0 and not more than 4.0.

The average introduced amount of the substituent derived from an amine compound is the average value of the number of substituents in the formula (1), and can be measured by such analytic means as time-of-flight mass spectrometry (TOF-MS).

Specific examples of the copper phthalocyanine derivative having a substituent derived from an amine compound are given here.

(1) A copper phthalocyanine amine derivative represented by the formula (1) above in which at least one of R₁, R₂, R₃ and R₄ is formula (A) above.

(2) A copper phthalocyanine sulfonic acid amine derivative represented by the formula (1) above in which at least one of R₁, R₂, R₃ and R₄ is formula (B) above.

(3) A copper phthalocyanine dialkylamine derivative represented by the formula (1) above in which at least one of R₁, R₂, R₃ and R₄ is formula (C) above.

(4) A copper phthalocyanine diaminoalkane derivative represented by the formula (1) above in which at least one of R₁, R₂, R₃ and R₄ is formula (D) above.

(5) A copper phthalocyanine dialkylaminoalkane derivative represented by the formula (1) above in which at least one of R₁, R₂, R₃ and R₄ is formula (E) above.

(6) A copper phthalocyanine dialkylaminoalkyl sulfonamide derivative represented by the formula (1) above in which at least one of R₁, R₂, R₃ and R₄ is formula (F) above.

(7) A copper phthalocyanine dialkyl polyethylene diamine alkane derivative represented by the formula (1) above in which at least one of R₁, R₂, R₃ and R₄ is formula (G) above.

(8) A copper phthalocyanine dialkyl polypropylene diamine alkane derivative represented by the formula (1) above in which at least one of R₁, R₂, R₃ and R₄ is formula (H) above.

A known binder resin may be used as the binder resin contained in the toner particle as long as it has fixing properties on adherends such as paper or plastic film, and as long as it is insoluble in the cationically polymerizable liquid monomer.

The standard for insolubility in the cationically polymerizable liquid monomer here may be that not more than 1 mass part of the binder resin dissolves in 100 mass parts of the cationically polymerizable liquid monomer at 25° C.

Specific examples of the binder resin include vinyl resins, polyester resins, polyurethane resins, epoxy resins, polyamide resins, polyimide resins, silicon resins, phenol resins, melamine resins, urea resins, aniline resins, ionomer resins, polycarbonate resins and the like. Two or more of these resins may also be used together.

Of these, it is desirable to use at least one vinyl resin, polyester resin, polyurethane resin or epoxy resin, and especially desirable to use at least one polyester resin or vinyl resin.

The polyester resin is not particularly limited, but is preferably a condensate of a diol and a dicarboxylic acid. Monovalent or trivalent or higher valent alcohols and carboxylic acids may also be used in order to adjust the acid value and the SP value.

Examples of the diol include butanediol, pentanediol, hexanediol, heptanediol, octanediol, nonanediol, decanediol, neopentyl glycol, 1,4-butenediol, 1,4-cyclohexane dimethanol, and bisphenol A ethylene oxide adduct and/or propylene oxide adduct and the like.

Examples of monovalent alcohols include n-butanol, isobutanol, sec-butanol, n-hexanol, n-octanol, lauryl alcohol, 2-ethylhexanol, decanol, cyclohexanol, benzyl alcohol, dodecyl alcohol and the like.

Examples of trivalent or higher valent alcohols include aromatic alcohols such as 1,3,5-trihydroxymethyl benzene; and aliphatic alcohols such as pentaerythritol, dipentaerythritol, tripentaerythritol, 1,2,4-butanetriol, 1,2,5-pentanetriol, glycerin, 2-methylpropanetriol, 2-methyl-1,2,4-butanetriol, trimethylolethane and trimethylolpropane and the like.

Examples of dicarboxylic acids include maleic acid, fumaric acid, citraconic acid, itaconic acid, glutaconic acid, phthalic acid, isophthalic acid, terephthalic acid, succinic acid, adipic acid, sebacic acid, azelaic acid, malonic acid, n-dodecenylsuccinic acid, isododecenylsuccinic acid, n-dodecylsuccinic acid, isododecylsuccinic acid, n-octenylsuccinic acid, n-octylsuccinic acid, isooctenylsuccinic acid, isooctylsuccinic acid, anhydrides of these acids and lower alkyl esters of these.

Examples of monovalent carboxylic acids include benzoic acid, naphthalenecarboxylic acid, salicylic acid, 4-methylbenzoic acid, 3-methylbenzoic acid, phenoxyacetic acid, biphenylcarboxylic acid, acetic acid, propionic acid, butyric acid, octanoic acid, decanoic acid, dodecanoic acid, stearic acid and other monocarboxylic acids.

Examples of trivalent or higher valent carboxylic acids include aromatic carboxylic acids such as 1,2,4-benzenetricarboxylic acid (trimellitic acid), 2,5,7-naphthalenetricarboxylic acid, 1,2,4-naphthalenetricarboxylic acid and pyromellitic acid, aliphatic carboxylic acids such as 1,2,4-butanetricarboxylic acid, 1,2,5-hexanetricarboxylic acid and 1,3-dicarboxyl-2-methyl-2-methylenecarboxypropane, and acid anhydrides thereof and lower alkyl esters of these.

Examples of monomers constituting the vinyl resin include styrene, methacrylic acid, acrylic acid, methyl methacrylate, methyl acrylate, butyl methacrylate, butyl acrylate and the like.

The method for manufacturing a curable liquid developer of the present invention is a method for manufacturing a curable liquid developer comprising a toner particle containing a binder resin and a pigment, a toner particle dispersing agent, and a cationically polymerizable liquid monomer that does not dissolve the binder resin, the method comprising

a step (i) of preparing a pigment-dispersed solution containing the binder resin, the pigment, the toner particle dispersing agent and a solvent that dissolves the binder resin,

a step (ii) of preparing a liquid mixture containing the pigment-dispersed solution and the cationically polymerizable liquid monomer, and

a step (iii) of removing the solvent from the liquid mixture, wherein

the pigment contains a copper phthalocyanine derivative represented by formula (1) above.

When such a coacervation method is used as the method of manufacturing the liquid developer, the pigment containing the copper phthalocyanine derivative is more easily included inside the toner particle.

Moreover, dark polymerization reactions can be further suppressed by using a formulation that facilitates inclusion of the pigment containing the copper phthalocyanine derivative in the toner particle.

For example, this can be achieved by using a toner particle dispersing agent with basic properties. Using the basic particle dispersing agent, a repulsive force occurs with the pigment containing a copper phthalocyanine derivative having a substituent derived from an amine compound in the step (i) and/or the step (ii).

When the cationically polymerizable liquid polymer that does not dissolve the binder resin is added in the step (ii), the binder resin that was dissolved in the solvent in the step (i) is precipitated together with the pigment in the form of a toner particle.

When the aforementioned repulsive force is present at this stage, the pigment containing the copper phthalocyanine derivative is more easily included inside the toner particle.

A resin having an acid value of at least 8 mg KOH/g may be used as the binder resin. Using a resin with an acid value of at least 8 mg KOH/g, binding force is generated between the binder resin and the copper phthalocyanine derivative having a substituent derived from an amine compound, and the pigment containing the copper phthalocyanine derivative is more easily included within the toner particle.

When only a resin with an acid value of less than 8 mg KOH/g is used as the binder resin, the binding force tends to be weaker between the basic toner particle dispersing agent and the copper phthalocyanine derivative having a substituent derived from an amine compound.

The acid value of the binder resin is preferably at least 8 mg KOH/g and not more than 40 mg KOH/g, or more preferably at least 10 mg KOH/g and not more than 30 mg KOH/g.

When the liquid developer is manufactured by a coacervation method, the pigment containing a copper phthalocyanine derivative having a substituent derived from an amine compound is more likely to be on the inside of the toner particle if a basic toner particle dispersing agent and one or more kinds of binder resins having acid values of at least 8 mg KOH/g are used. As a result, dark polymerization reactions are more effectively suppressed because the pigment containing the copper phthalocyanine derivative is less likely to contact the cationically polymerizable liquid monomer used as a carrier liquid.

However, the method for manufacturing the liquid developer need not be a coacervation method. For example, a toner particle manufactured by a dry pulverization method, wet pulverization method or the like may be dispersed together with a toner particle dispersing agent in a cationically polymerizable liquid monomer.

There are no particular limitations on what solvent can be used in the step (i) above as long as it is a solvent that dissolves the binder resin.

A solvent that dissolves the binder resin here may mean that at least about 333 mass parts of the binder resin dissolve in 100 mass parts of the solvent at 25° C. Examples include ethers such as tetrahydrofuran, ketones such as methyl ethyl ketone and cyclohexanone, esters such as ethyl acetate, and halides such as chloroform. An aromatic hydrocarbon such as toluene or benzene may also be used if it is capable of dissolving the binder resin.

A liquid mixture of the pigment-dispersed solution and the cationically polymerizable liquid monomer that does not dissolve the binder resin is prepared in the step (ii) above, but a solvent, other than the cationically polymerizable liquid monomer, that does not dissolve the binder resin may also be used in place of the cationically polymerizable liquid monomer.

Silicone oil or a hydrocarbon-based organic solvent such as n-hexane or isoparaffin solvents may be used by preference as the solvent that does not dissolve the binder resin.

The standard for a solvent that does not dissolve the binder resin may be that not more than 1 mass part of the binder resin dissolves in 100 mass parts of the solvent at 25° C.

When a toner particle has been produced using this solvent that does not dissolve the binder resin, the liquid developer may be manufactured by a method of adding the cationically polymerizable liquid monomer after the toner particle is produced, or by a method of substituting the cationically polymerizable liquid monomer for the solvent.

The cationically polymerizable liquid monomer is not particularly limited, and may be selected from those that do not dissolve the binder resin contained in the toner particle.

Specifically, a cationically polymerizable monomer may be selected in which not more than 1 mass part of the binder resin dissolves per 100 mass parts of the cationically polymerizable liquid monomer at 25° C. Specific examples include cyclic ether compounds such as epoxy compounds and oxetane compounds, and vinyl ether compounds and the like.

Of these, a vinyl ether compound is preferred. Because vinyl ether compounds have little electron density bias in the molecule, a curable liquid developer with strong resistance, low viscosity and high sensitivity can be obtained by using a vinyl ether compound.

A vinyl ether compound here means a compound having a vinyl ether structure (—CH═CH—O—C—).

This vinyl ether structure is more preferably represented by R′—CH═CH—O—C— (in which R′ is a hydrogen or C₁₋₃ alkyl, and is preferably a hydrogen or methyl).

Moreover, in a preferred embodiment the vinyl ether compound is a compound that does not have any hetero atoms apart from the vinyl ether structure.

A hetero atom here means an atom other than a carbon atom or hydrogen atom.

If the vinyl ether compound is a compound that does not have any hetero atoms apart from the vinyl ether structure, electron density bias in the molecule becomes less likely, elution of the toner particle dispersing agent can be easily suppressed, and the curing properties can be further improved.

In another preferred embodiment, the vinyl ether compound is a compound that does not have any carbon-carbon double bonds apart from the vinyl ether structure.

If the vinyl ether compound is a compound that does not have any carbon-carbon double bonds apart from the vinyl ether structure, electron density bias in the molecule becomes less likely, elution of the toner particle dispersing agent can be easily suppressed, and the curing properties can be further improved.

The vinyl ether compound is preferably a compound represented by formula (2) below.

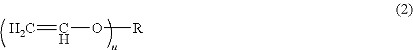

In formula (2), u is an integer of at least 1 and not more than 4 representing the number of vinyl ether structures in one molecule; and R is a u-valent hydrocarbon group.

The u is preferably an integer of at least 1 and not more than 3.

R is preferably a group selected from a C₁₋₂₀ linear or branched, saturated or unsaturated aliphatic hydrocarbon group, a C₅₋₁₂ saturated or unsaturated alicyclic hydrocarbon group and a C₆₋₁₄ aromatic hydrocarbon group, and the alicyclic hydrocarbon group and aromatic hydrocarbon group may also have C₁₋₄ saturated or unsaturated aliphatic hydrocarbon groups.

R above is more preferably a C₄₋₁₈ linear or branched saturated aliphatic hydrocarbon group.

Specific examples of the vinyl ether compound (Example Compounds B-1 to B-30) are given below, but these are only examples.

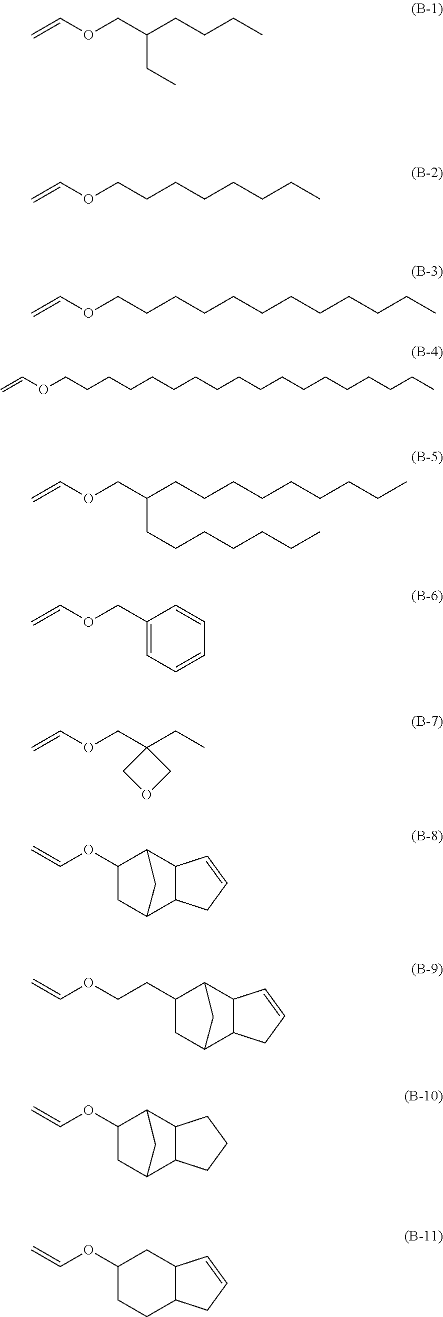

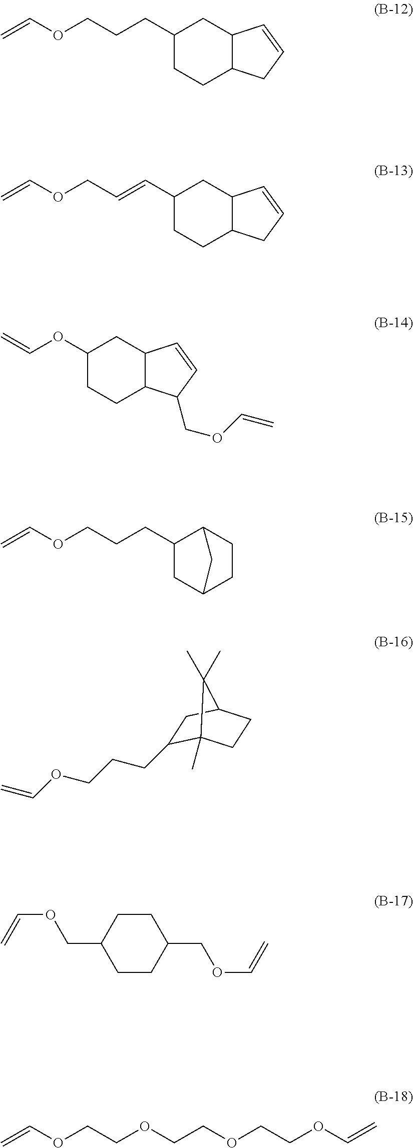

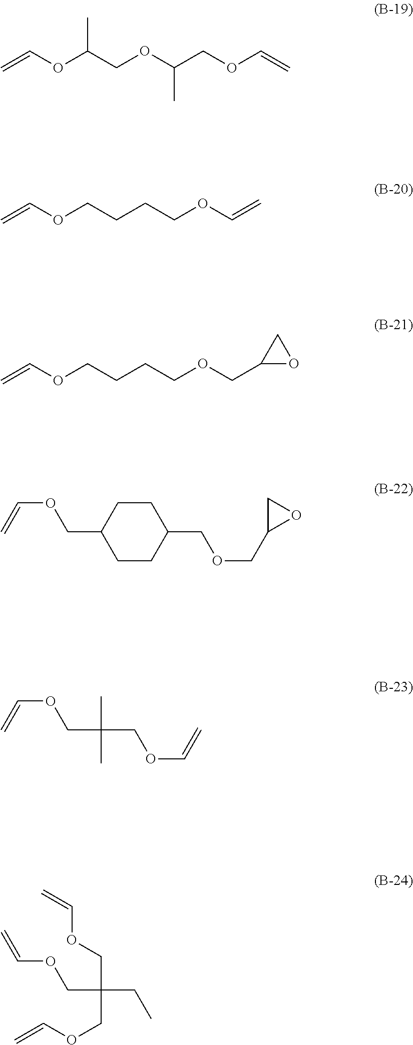

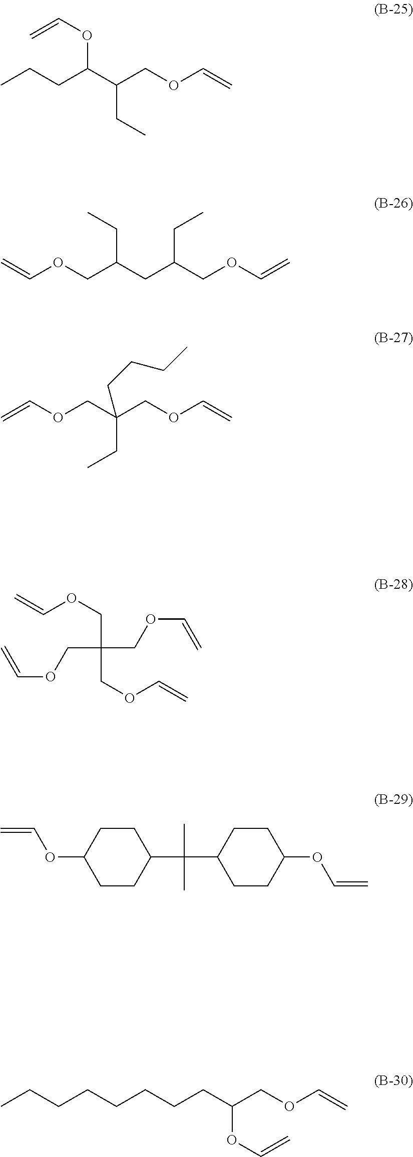

Of these, preferred examples include dodecyl vinyl ether (B-3), dicyclopentadiene vinyl ether (B-8), cyclohexane dimethanol divinyl ether (B-17), tricyclodecane vinyl ether (B-10), trimethylolpropane trivinyl ether (B-24), 2-ethyl-1,3-hexanediol divinyl ether (B-25), 2,4-diethyl-1,5-pentanediol divinyl ether (B-26), 2-butyl-2-ethyl-1,3-propanediol divinyl ether (B-27), neopentyl glycol divinyl ether (B-23), pentaerythritol tetravinyl ether (B-28), 1,2-decanediol divinyl ether (B-30) and the like.

The pigment may also contain a pigment other than the copper phthalocyanine derivative represented by formula (1).

For example, examples of pigments exhibiting blue or cyan color include the following: C.I. Pigment Blue 2, 3, 15:2, 15:3, 15:4, 16 and 17; C.I. Vat Blue 6; and C.I. Acid Blue 45.

A pigment dispersing agent or pigment dispersing auxiliary agent may also be added when dispersing the pigment. Examples of pigment dispersing agents include hydroxyl group-containing carboxylic acid esters, salts of long-chain polyaminoamides and high-molecular-weight acid esters, salts of high-molecular-weight polycarboxylic acids, high-molecular-weight unsaturated acid esters, high-molecular-weight copolymers, polyesters and modified polyesters, modified polyacrylates, aliphatic polyvalent carboxylic acids, naphthalene sulfonic acid formalin condensates, polyoxyethylene alkyl phosphate esters, and pigment derivatives and the like.

A commercial pigment dispersing agent may also be used, such as Lubrizol Japan. Solsperse series and Toyobo Co., Ltd. Vylon® UR series.

A synergist suited to the specific type of pigment may also be used as a pigment dispersing auxiliary agent. The pigment dispersing agent and pigment dispersing auxiliary agent are preferably added in the amount of at least 1 mass part and not more than 300 mass parts per 100 mass parts of the pigment.

The method of adding the pigment dispersing agent or pigment dispersing auxiliary agent is not particularly limited, but from the standpoint of pigment dispersibility they are preferably added in the step of dispersing the pigment.

The toner particle dispersing agent stably disperses the toner particle in the cationically polymerizable liquid monomer. The structure of the toner particle dispersing agent is not particularly limited, but a toner particle dispersing agent with basic properties is preferred. The dispersion stability of the toner particle over time can be further improved by using a toner particle dispersing agent with basic properties.

A known dispersing agent may be used as the toner particle dispersing agent.

Examples of commercial dispersing agents include Ajisper PN411 (higher fatty acid ester, neutral), Ajisper PB817 (reaction product of polyallylamine and 12-hydroxystearic acid self-condensate, basic) (both manufactured by Ajinomoto Fine-Techno Co., Inc.), and Solsperse 11200, 13940 (reaction products of polyethylenepolyamine and 12-hydroxystearic acid self-condensate, basic), 17000 and 18000 (all manufactured by Lubrizol Japan) and the like. One of these toner particle dispersing agents alone or a combination of two or more may be used.

To maintain dispersion stability and curability, the content of the toner particle dispersing agent is preferably at least 0.5 mass parts and not more than 20 mass parts per 100 mass parts of the toner particle.

The curable liquid developer may also contain a photopolymerization initiator.

The photopolymerization initiator is a compound that generates acids and radicals in response to light of a specific wavelength. Examples of this photopolymerization initiator include, but are not limited to, onium salt compounds, sulfone compounds, sulfonic acid ester compounds, sulfonimide compounds, diazomethane compounds and the like.

To prevent a decrease in the volume resistivity of the cationically polymerizable liquid monomer, the photopolymerization initiator represented by formula (3) below may be used for example.

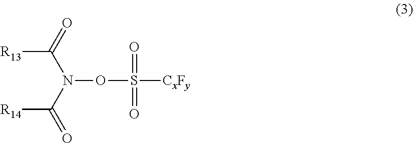

In formula (3), R₁₃ and R₁₄ bind together to form a ring structure, x represents an integer of at least 1 and not more than 8, and y represents an integer of at least 3 and not more than 17.

The compound represented by formula (3) is photolyzed by UV irradiation, generating the strong acid sulfonic acid. A sensitizer may also be included, and absorption of UV rays by the sensitizer can be used as a trigger to decompose the photopolymerization initiator and generate sulfonic acid.

The ring structure formed by binding of R₁₃ and R₁₄ above may be a 5-member ring or 6-member ring for example. Specific examples of ring structures formed by binding of R₁₃ and R₁₄ include a succinic acid imide structure, phthalic acid imide structure, norbornene dicarboximide structure, naphthalene dicarboximide structure, cyclohexane dicarboximide structure, epoxycyclohexene dicarboximide structure and the like.

This ring structure may also have an alkyl group, alkyloxy group, alkylthio group, aryl group, aryloxy group, arylthio group or the like as a substituent.

Examples of CₓF_{y} in formula (3) above include a linear alkyl group having a hydrogen atom substituted with a fluorine atom (RF1), a branched alkyl group having a hydrogen atom substituted with a fluorine atom (RF2), a cycloalkyl group having a hydrogen atom substituted with a fluorine atom (RF3) and an aryl group having a hydrogen atom substituted with a fluorine atom (RF4).

Examples of the linear alkyl group having a hydrogen atom substituted with a fluorine atom (RF1) include trifluoromethyl (x=1, y=3), pentafluoroethyl (x=2, y=5), heptafluoro-n-propyl (x=3, y=7), nonafluoro-n-butyl (x=4, y=9), perfluoro-n-hexyl (x=6, y=13) and perfluoro-n-octyl (x=8, y=17) groups and the like.

Examples of the branched alkyl group having a hydrogen atom substituted with a fluorine atom (RF2) include perfluoroisopropyl (x=3, y=7), perfluoro-tert-butyl (x=4, y=9) and perfluoro-2-ethylhexyl (x=8, y=17) groups and the like.

Examples of the cycloalkyl group having a hydrogen atom substituted with a fluorine atom (RF3) include perfluorocyclobutyl (x=4, y=7), perfluorocyclopentyl (x=5, y=9), perfluorocyclohexyl (x=6, y=11) and perfluoro(1-cyclohexyl)methyl (x=7, y=13) groups and the like.

Examples of the aryl group having a hydrogen atom substituted with a fluorine atom (RF4) include pentafluorophenyl (x=6, y=5) and 3-trifluoromethyltetrafluorophenyl (x=7, y=7) groups and the like.

From the standpoint of availability and degradability of the sulfonic acid ester moiety, CₓF_{y} in the formula (3) above is preferably a linear alkyl group (RF1), branched alkyl group (RF2) or aryl group (RF4). More preferably, it is a linear alkyl group (RF1) or aryl group (RF4). Still more preferably, it is a trifluoromethyl group (x=1, y=3), pentafluoroethyl group (x=2, y=5), heptafluoro-n-propyl group (x=3, y=7), nonafluoro-n-butyl group (x=4, y=9) or pentafluorophenyl group (x=6, y=5).

For the photopolymerization initiator, one kind alone or a combination of two or more kinds may be used. The content of the photopolymerization initiator in the curable liquid developer is not particularly limited, but is preferably at least 0.01 mass parts and not more than 5 mass parts, or more preferably at least 0.05 mass parts and not more than 1 mass part, or still more preferably at least 0.1 mass parts and not more than 0.5 mass parts per 100 mass parts of the cationically polymerization liquid monomer.

Specific examples of the photopolymerization initiator represented by formula (3) above (Example Compounds A-1 to A-27) are given below, but the present invention is not limited to these examples.

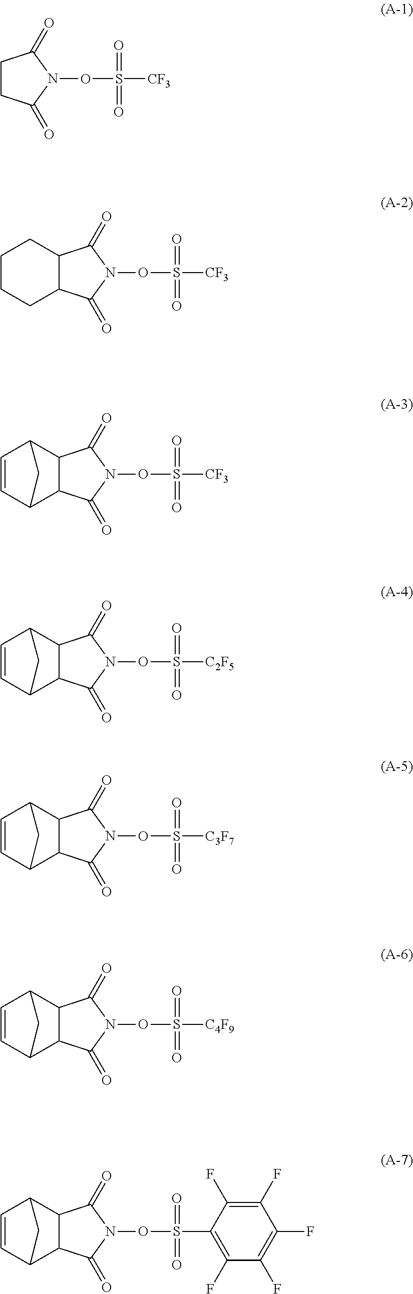

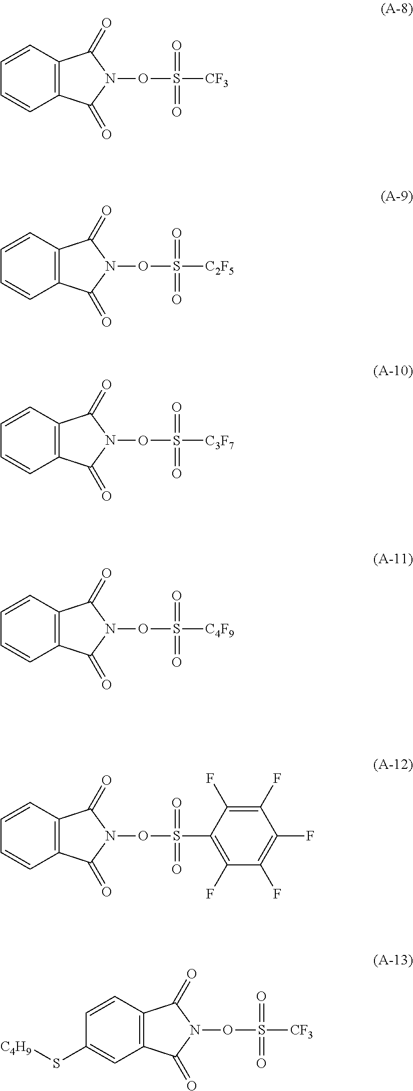

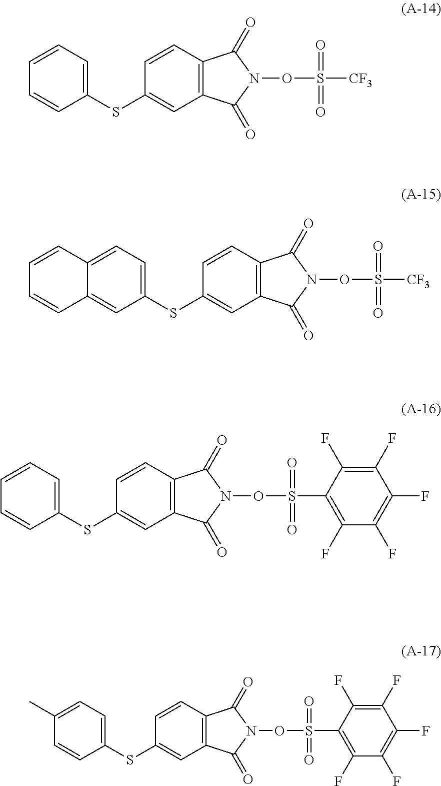 [SMILES: O=C1c2ccc(Sc3ccccc3)cc2C(=O)N1OS(=O)(=O)C(F)(F)F ; O=C1c2ccc(Sc3ccc4ccccc4c3)cc2C(=O)N1OS(=O)(=O)C(F)(F)F ; O=C1c2ccc(Sc3ccccc3)cc2C(=O)N1OS(=O)(=O)c1c(F)c(F)c(F)c(F)c1F ; Cc1ccc(Sc2ccc3c(c2)C(=O)N(OS(=O)(=O)c2c(F)c(F)c(F)c(F)c2F)C3=O)cc1]

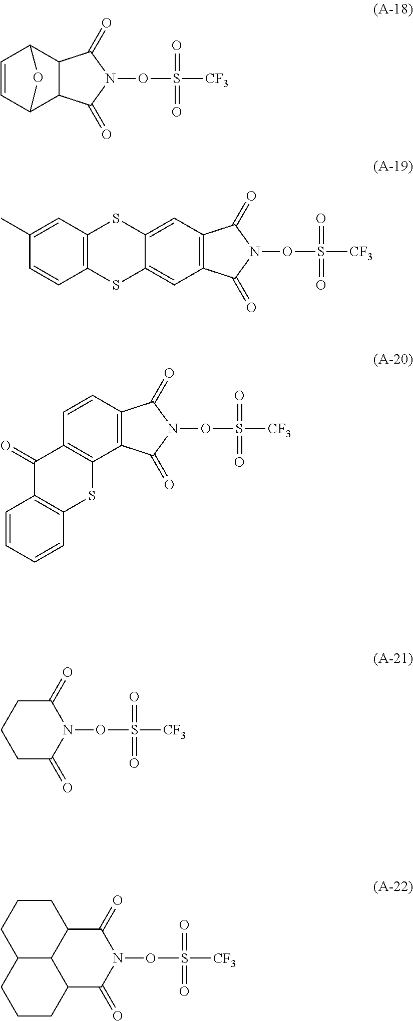 [SMILES: O=C1C2C3C=CC(O3)C2C(=O)N1OS(=O)(=O)C(F)(F)F ; Cc1ccc2sc3cc4c(=O)n(OS(=O)(=O)C(F)(F)F)c(=O)c4cc3sc2c1 ; O=C1c2ccc3c(=O)c4ccccc4sc3c2C(=O)N1OS(=O)(=O)C(F)(F)F ; O=C1CCCC(=O)N1OS(=O)(=O)C(F)(F)F ; O=C1C2CCCC3CCCC(C(=O)N1OS(=O)(=O)C(F)(F)F)C32]

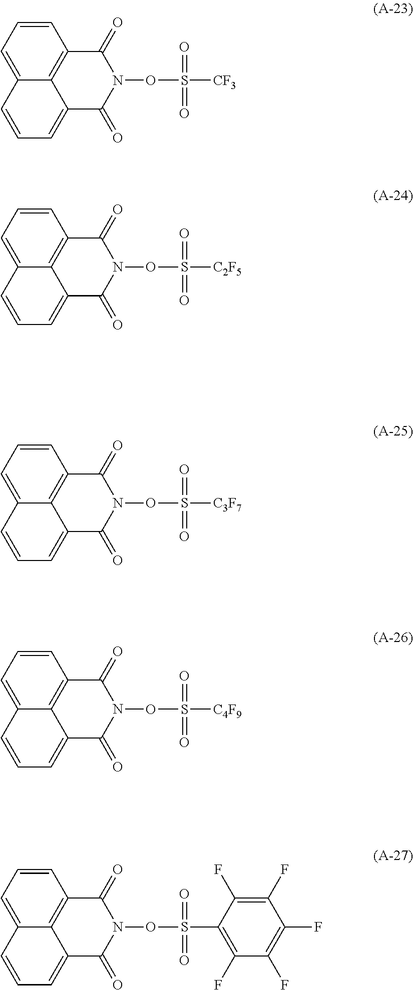

The curable liquid developer may also contain a charge control agent as necessary. A known charge control agent may be used.

Examples of specific compounds include the following: oils and fats such as linseed oil and soybean oil; alkyd resins, halogen polymers, aromatic polycarboxylic acids, water-soluble dyes containing acidic groups, oxidation condensation products of aromatic polyamines, and metal soaps such as cobalt naphthenate, nickel naphthenate, iron naphthenate, zinc naphthenate, cobalt octylate, nickel octylate, zinc octylate, cobalt dodecylate, nickel dodecylate, zinc dodecylate, aluminum stearate and cobalt 2-ethylhexanoate; sulfonate metal salts such as petroleum-based metal sulfonate salts and metal salts of sulfosuccinic acid esters; phospholipids such as lecithin and hydrogenated lecithin; salicylic acid metal salts such as t-butyl salicylic acid metal complexes; and polyvinylpyrrolidone resin, polyamide resin, sulfonic acid-containing resins, hydroxybenzoic acid derivatives and the like.

A charge adjuvant may also be included in the toner particle as necessary with the aim of adjusting the chargeability of the toner particle. A known charge adjuvant may be used.

Examples of specific compounds include metal soaps such as zirconium naphthenate, cobalt naphthenate, nickel naphthenate, iron naphthenate, zinc naphthenate, cobalt octylate, nickel octylate, zinc octylate, cobalt dodecylate, nickel dodecylate, zinc dodecylate, aluminum stearate, aluminum tristearate and cobalt 2-ethylhexanoate; sulfonic acid metal salts such as petroleum-based metal sulfonate salts and metal salts of sulfosuccinic acid esters; phospholipids such as lecithin; salicylic acid metal salts such as t-butyl salicylic acid metal complexes; and polyvinylpyrrolidone resin, polyamide resin, sulfonic acid-containing resins, hydroxybenzoic acid derivatives and the like.

A sensitizer may be added to the curable liquid developer as necessary with the aim of improving the acid-generating efficiency of the photopolymerization initiator, lengthening the photosensitive wavelength or the like.

The sensitizer is not particularly limited as long as it can increase the sensitivity of the photopolymerization initiator by an electron transfer mechanism or energy transfer mechanism.

Specific examples include aromatic polycondensed ring compounds such as anthracene, 9,10-dialkoxyanthracene, pyrene and perylene, aromatic ketone compounds such as acetophenone, benzophenone, thioxanthone and Michler's ketone, and heterocyclic compounds such as phenothiazine, and N-aryloxazolidinone.

The content of the sensitizer is selected appropriately according to the object, but is generally about at least 0.1 mass parts and not more than 10 mass parts, or preferably at least 1 mass part and not more than 5 mass parts per 1 mass part of the photopolymerization initiator.

A sensitizing aid may also be added to the curable liquid developer with the aim of increasing the electron transfer efficiency or energy transfer efficiency between the sensitizer and the photopolymerization initiator.

Specific examples include naphthalene compounds such as 1,4-dihydroxynaphthalene, 1,4-dimethoxynaphthalene, 1,4-diethoxynaphthalene, 4-methoxy-1-naphthol and 4-ethoxy-1-naphthol, and benzene compounds such as 1,4-dihydroxybenzene, 1,4-dimethoxybenzene, 1,4-diethoxybenzene, 1-methoxy-4-phenol and 1-ethoxy-4-phenol.

The content of the sensitizing aid is selected appropriately according to the object, but is commonly about at least 0.1 mass parts and not more than 10 mass parts, or more preferably at least 0.5 mass parts and not more than 5 mass parts per 1 mass part of the sensitizer.

A cationic polymerization inhibitor may also be added to the curable liquid developer.

The cationic polymerization inhibitor may be an alkali metal compound and/or alkali earth metal compound, or an amine.

Examples of amines include alkanolamines, N,N-dimethylalkylamines, N,N-dimethylalkenylamines and N,N-dimethylalkynylamines.

Specific examples include triethanolamine, triisopropanolamine, tributanolamine, N-ethyldiethanolamine, propanolamine, n-butylamine, sec-butylamine, 2-aminoethanol, 2-methylaminoethanol, 3-methylamino-1-propanol, 3-methylamino-1,2-propanediol, 2-ethylaminoethanol, 4-ethylamino-1-butanol, 4-(n-butylamino)-1-butanol, 2-(t-butylamino)ethanol, N,N-dimethylundecanolamine, N,N-dimethyldodecanolamine, N,N-dimethyltridecanolamine, N,N-dimethyltetradecanolamine, N,N-dimethylpentadecanolamine, N,N-dimethylnonadecylamine, N,N-dimethylicosylamine, N,N-dimethyleicosylamine, N,N-dimethylhenicosylamine, N,N-dimethyldocosylamine, N,N-dimethyltricosylamine, N,N-dimethyltetracosylamine, N,N-dimethylpentacosylamine, N,N-dimethylpentanolamine, N,N-dimethylhexanolamine, N,N-dimethylheptanolamine, N,N-dimethyloctanolamine, N,N-dimethylnonanolamine, N,N-dimethyldecanolamine, N,N-dimethylnonylamine, N,N-dimethyldecylamine, N,N-dimethylundecylamine, N,N-dimethyldodecylamine, N,N-dimethyltridecylamine, N,N-dimethyltetradecylamine, N,N-dimethylpentadecylamine, N,N-dimethylhexadecylamine, N,N-dimethylheptadecylamine and N,N-dimethyloctadecylamine. Apart from these, a quaternary ammonium salt or the like may also be used. A secondary amine is particularly desirable as the cationic polymerization inhibitor.

The content of the cationic polymerization inhibitor in the curable liquid developer is preferably at least 1 ppm and not more than 5,000 ppm by mass.

In addition to those explained above, various known additives may be used as necessary in the curable liquid developer with the aim of improving recording medium compatibility, storage stability, image storability, and various other properties. Examples include surfactants, lubricants, fillers, antifoaming agents, UV absorbers, antioxidants, antifading agents, antibacterial agents, rust inhibitors and the like, and these may be selected and used appropriately.

The curable liquid developer may be used favorably in ordinary electrophotographic image forming apparatuses. The method for curing the liquid developer may be a method using UV light, an electron beam (EB) system or the like.

In curing methods using UV light, the liquid developer is first transferred to the recording medium, and then immediately exposed to ultraviolet light to cure the developer and fix the image.

A mercury lamp, metal halide lamp, excimer laser, ultraviolet laser, cold cathode tube, hot cathode tube, black light, light emitting diode (LED) or the like may be used as the light source for exposing the developer to ultraviolet light. Of these, a zonal metal halide lamp, cold cathode tube, hot cathode tube, mercury lamp, black light or LED is preferred.

The ultraviolet radiation dose is preferably at least 0.1 mJ/cm² and not more than 1,000 mJ/cm².

The measurement methods used in the present invention are shown below.

Determining Structure of Compound or the Like

The structure of the compound or the like is determined by the following methods.

The ¹H-NMR and ¹³C-NMR spectra are measured using an ECA-400 (400 MHz) manufactured by JEOL Ltd.

Measurement is performed at 25° C. in a deuterated solvent containing tetramethylsilane as an internal standard substance. The chemical shift value is shown as a ppm shift value (8 value) given 0 as the value of the internal standard substance (tetramethylsilane).

Method for Measuring Acid Value of Binder Resin

The acid value of the binder resin is measured based on JIS K 0070-1992.

Specifically, this is done as follows.
1) 0.5 to 2.0 g of sample is weighed precisely. The mass here is given as M (g).

2) The sample is placed in a 50 mL beaker, and dissolved by addition of 25 mL of a mixed tetrahydrofuran/ethanol (2/1) solution.

3) Titration is performed with a potentiometric titration apparatus (automated titration measurement system “COM-2500” manufactured by Hiranuma Sangyo Co., Ltd.) using an 0.1 mol/L KOH ethanol solution.

4) The amount of the KOH solution used here is given as S (mL). A blank is measured at the same time, and the amount of KOH used therein is given as B (mL).

5) The acid value is calculated by the following formula, in which f is the factor of the KOH solution.

Acid value [mg KOH/g]=(S−B)×f×5.61/M

Method for Measuring Molecular Weight Distribution of Binder Resin

The molecular weight distribution of the binder resin is measured by gel permeation chromatography (GPC) and calculated as a polystyrene equivalent. The methods for measuring molecular weight by GPC are as follows.

The sample is added to the following eluent to a sample concentration of 1.0 mass %, and left to dissolve by still standing for 24 hours at room temperature, and the resulting solution is filtered with a solvent-resistant membrane filter with a pore diameter of 0.20 μm to obtain a sample solution that is then measured under the following conditions.

Equipment: High-speed GPC apparatus “HLC-8220GPC” (manufactured by Tosoh Corporation)

Columns: LF-804×2

Eluent: Tetrahydrofuran (THF)

Flow rate: 1.0 mL/min

Oven temperature: 40° C.

Sample injection volume: 0.025 mL

A molecular weight calibration curve prepared using standard polystyrene resins (TSK standard polystyrene F-850, F-450, F-288, F-128, F-80, F-40, F-20, F-10, F-4, F-2, F-1, A-5000, A-2500, A-1000, A-500 manufactured by Tosoh Corporation) is used in calculating the molecular weight of the sample.

Method for Measuring Volume-Based Average Particle Diameter (D50) of Toner Particle

The volume-based average particle diameter (hereunder sometimes simply called the D50) of the toner particle is measured in the corresponding carrier liquid with a dynamic light scattering (DLS) particle size distribution measurement apparatus (trade name: Nanotrac 150, manufactured by MicrotracBEL Corp.).

### EXAMPLES

The present invention is explained in detail below by means of examples, but the present invention is not limited by these examples. Unless otherwise specified, “parts” and “%” indicate “mass parts” and “mass %”.

Manufacturing Example of Copper Phthalocyanine Pigment 1

| | |
|---|---|
| C.I. Pigment Blue 15:3 | 14 parts |
| Copper phthalocyanine sulfonic acid amine derivative | 2 parts |
| (substituent of formula (B) above, average introduced | |
| amount of substituent 1.6) | |
| Tetrahydrofuran | 100 parts |

This formulation was mixed for 5 hours in a paint shaker with 30 parts of 1 mm diameter zirconia beads, and filtered with a metal mesh to remove the zirconia beads.

The tetrahydrofuran was removed by evaporation from the resulting dispersion of the copper phthalocyanine pigment 1 with a rotary evaporator, and then dried at 50° C. in a vacuum drying oven to obtain the copper phthalocyanine pigment 1.

Manufacturing Example of Copper Phthalocyanine Pigment 2

| | |
|---|---|
| C.I. Pigment Blue 15:3 | 14 parts |
| Copper phthalocyanine amine derivative (substituent | 2 parts |
| ″—NH₂″, average introduced amount of substituent 1.3) | |
| Tetrahydrofuran | 100 parts |

The copper phthalocyanine pigment 2 was obtained as in the manufacturing example of the copper phthalocyanine pigment 1 except that the above formulation was used.

Manufacturing Example of Copper Phthalocyanine Pigment 3

| | |
|---|---|
| C.I. Pigment Blue 15:3 | 14 parts |
| Copper phthalocyanine sulfonic acid amine derivative | 1.4 parts |
| (substituent of formula (B) above, average introduced | |
| amount of substituent 1.3) | |
| Tetrahydrofuran | 100 parts |

The copper phthalocyanine pigment 3 was obtained as in the manufacturing example of the copper phthalocyanine pigment 1 except that the above formulation was used.

Manufacturing Example of Copper Phthalocyanine Pigment 4

C.I. Pigment Blue 15:3 was used as is as the copper phthalocyanine pigment 4.

Manufacturing Example of Copper Phthalocyanine Pigment 5

| | |
|---|---|
| C.I. Pigment Blue 15:3 | 14 parts |
| Copper phthalocyanine sulfonic acid derivative (substituent | 2 parts |
| ″—SO₃H″, introduced amount of substituent 1.6) | |
| Tetrahydrofuran | 100 parts |

The copper phthalocyanine pigment 5 was obtained as in the manufacturing example of the copper phthalocyanine pigment 1 except that the above formulation was used.

Manufacturing Example of Copper Phthalocyanine Pigment 6

| | |
|---|---|
| C.I. Pigment Blue 15:3 | 14 parts |
| Copper phthalocyanine amine derivative (substituent | 2 parts |
| ″—N(CH₃)₂″, average introduced amount of substituent 1.6) | |
| Tetrahydrofuran | 100 parts |

The copper phthalocyanine pigment 6 was obtained as in the manufacturing example of the copper phthalocyanine pigment 1 except that the above formulation was used.

Manufacturing Example of Copper Phthalocyanine Pigment 7

| | |
|---|---|
| C.I. Pigment Blue 15:3 | 14 parts |
| Copper phthalocyanine amine derivative (substituent | 2 parts |
| ″—CH(CH₂NH₂)₂″, average introduced amount of substituent | |
| 1.6) | |
| Tetrahydrofuran | 100 parts |

The copper phthalocyanine pigment 7 was obtained as in the manufacturing example of the copper phthalocyanine pigment 1 except that the above formulation was used.

Manufacturing Example of Copper Phthalocyanine Pigment 8

| | |
|---|---|
| C.I. Pigment Blue 15:3 | 14 parts |
| Copper phthalocyanine amine derivative (substituent | 2 parts |
| ″—CH₂—N(CH₃)₂″, average introduced amount of substituent | |
| 1.6) | |
| Tetrahydrofuran | 100 parts |

The copper phthalocyanine pigment 8 was obtained as in the manufacturing example of the copper phthalocyanine pigment 1 except that the above formulation was used.

Manufacturing Example of Copper Phthalocyanine Pigment 9

| | |
|---|---|
| C.I. Pigment Blue 15:3 | 14 parts |
| Copper phthalocyanine sulfonamide derivative (substituent | 2 parts |
| ″—SO₂—NH—C₃H₆—N(CH₃)₂″, average introduced amount | |
| of substituent 1.6) | |
| Tetrahydrofuran | 100 parts |

The copper phthalocyanine pigment 9 was obtained as in the manufacturing example of the copper phthalocyanine pigment 1 except that the above formulation was used.

Manufacturing Example of Copper Phthalocyanine Pigment 10

| | |
|---|---|
| C.I. Pigment Blue 15:3 | 14 parts |
| Copper phthalocyanine amine derivative (substituent | 2 parts |
| ″—CH₂—NH—C₂H₄—NH(CH₃)″, average introduced amount | |
| of substituent 1.6) | |
| Tetrahydrofuran | 100 parts |

The copper phthalocyanine pigment 10 was obtained as in the manufacturing example of the copper phthalocyanine pigment 1 except that the above formulation was used.

Manufacturing Example of Copper Phthalocyanine Pigment 11

| | |
|---|---|
| C.I. Pigment Blue 15:3 | 14 parts |
| Copper phthalocyanine amine derivative (substituent | 2 parts |
| ″—CH₂—NH—C₃H₆—NH(CH₃)″, average introduced amount | |
| of substituent 1.6) | |
| Tetrahydrofuran | 100 parts |

The copper phthalocyanine pigment 11 was obtained as in the manufacturing example of the copper phthalocyanine pigment 1 except that the above formulation was used.

Manufacturing Example of Binder Resin 1

| | | |
|---|---|---|
| Bisphenol A ethylene oxide (2.5 mol) adduct | 55 | parts |
| Terephthalic acid | 40 | parts |
| Tetrabutyl titanate | 0.2 | parts |

These materials were combined and reacted for 10 hours at 220° C. under a nitrogen stream as the resulting water was distilled off.

Next, this was reacted under reduced pressure of at least 5 mmHg and not more than 20 mmHg and then cooled to 180° C., 5 parts of trimellitic anhydride were added, and the mixture was reacted for 2 hours under sealed conditions and normal pressure.

After completion of the reaction this was removed, cooled to room temperature and then pulverized to obtain a binder resin 1 (polyester resin).

The resulting binder resin 1 had a weight-average molecular weight (Mw) of 15,000 and an acid value of 10 mg KOH/g. 50 parts of the binder resin 1 were dissolved in 50 parts of tetrahydrofuran to obtain a binder resin 1 solution.

Manufacturing Example of Binder Resin 2

| | | |
|---|---|---|
| Bisphenol A ethylene oxide (2.5 mol) adduct | 55 | parts |
| Isophthalic acid | 16 | parts |
| Terephthalic acid | 16 | parts |
| Tetrabutyl titanate | 0.2 | parts |
| Trimellitic anhydride | 8 | parts |

The binder resin 2 was obtained as in the manufacturing example of the binder resin 1 except that the above materials were used. The resulting binder resin 2 had a weight-average molecular weight (Mw) of 16,000 and an acid value of 15 mg KOH/g. 50 parts of the binder resin 2 were dissolved in 50 parts of tetrahydrofuran to obtain a binder resin 2 solution.

Manufacturing Example of Binder Resin 3

| | | |
|---|---|---|
| Bisphenol A ethylene oxide (2.5 mol) adduct | 55 | parts |
| Terephthalic acid | 43 | parts |
| Tetrabutyl titanate | 0.2 | parts |
| Trimellitic anhydride | 2 | parts |

The binder resin 3 was obtained as in the manufacturing example of the binder resin 1 except that the above materials were used. The resulting binder resin 3 had a weight-average molecular weight (Mw) of 16,000 and an acid value of 8 mg KOH/g. 50 parts of the binder resin 3 were dissolved in 50 parts of tetrahydrofuran to obtain a binder resin 3 solution.

Manufacturing Example of Binder Resin 4

| | | |
|---|---|---|
| Bisphenol A ethylene oxide (2.5 mol) adduct | 55 | parts |
| Terephthalic acid | 45 | parts |
| Tetrabutyl titanate | 0.2 | parts |

The binder resin 4 was obtained as in the manufacturing example of the binder resin 1 except that the above materials were used. The resulting binder resin 4 had a weight-average molecular weight (Mw) of 16,000 and an acid value of 7 mg KOH/g. 50 parts of the binder resin 4 were dissolved in 50 parts of tetrahydrofuran to obtain a binder resin 4 solution.

Manufacturing Example of Pigment-Dispersed Resin

100 parts of a toluene solution (solids 50%) of a polycarbodiimide compound having an isocyanate group and a carbodiimide equivalent of 262 were combined with 8.5 parts of N-methyl diethanolamine, and maintained at about 100° C. for 3 hours to react the isocyanate groups and hydroxyl groups.

Next, 39.6 parts of an ε-caprolactone self-polycondensate having a terminal carboxy group and a number average molecular weight of 8,500 were added, and the temperature was maintained at about 80° C. for 2 hours to react the carbodiimide groups and carboxyl groups, after which the toluene was distilled off under reduced pressure to obtain a pigment-dispersed resin (solids 100%) with a number average molecular weight of about 13,000.

Manufacturing Example of Curable Liquid Developer 1

| | | |
|---|---|---|
| Copper phthalocyanine pigment 1 | 10 | parts |
| Pigment-dispersed resin | 10 | parts |
| Tetrahydrofuran | 80 | parts |

These were mixed and stirred for 1 hour in a paint shaker with 2 mm diameter glass beads to obtain a pigment-dispersed slurry 1. Next,

| | | |
|---|---|---|
| Pigment-dispersed slurry 1 | 60 | parts |
| Binder resin 1 solution | 80 | parts |
| Toner particle dispersing agent | 12 | parts |
| (Ajisper PB-817, basic, manufactured | | |
| by Ajinomoto Fine-Techno Co. , Inc.) | | |

were mixed with stirring at 40° C. in a high-speed dispersion apparatus (T.K. Robomix/T.K. Homogenizing Disper Model 2.5 blade manufactured by Primix Corporation) to obtain a pigment-dispersed solution 1.

Using a homogenizer (Ultra Turrax T50, manufactured by IKA®-Werke GmbH & Co. KG), 200 parts of 2-butyl-2-ethyl-1,3-propanediol divinyl ether (Example Compound B-27) were added little by little with high-speed stirring (rotational speed 15,000 rpm) to the resulting pigment-dispersed solution 1 (100 parts) to obtain a liquid mixture 1.

The resulting liquid mixture 1 was transferred to an eggplant flask, and subjected to ultrasound dispersion as the tetrahydrofuran was completely distilled off at 50° C. to obtain a toner particle dispersion 1.

The resulting toner particle dispersion 1 (10 parts) was centrifuged, the supernatant was removed by decantation, new 2-butyl-2-ethyl-1,3-propanediol divinyl ether was added in the same mass amount as the removed supernatant, and the particle was re-dispersed.

0.10 parts of hydrogenated lecithin (product name: Lecinol S-10, manufactured by Nikko Chemicals Co., Ltd.), 90 parts of 2-butyl-2-ethyl-1,3-propanediol divinyl ether (Example Compound B-27), 0.30 parts of a photopolymerization initiator (product name: NHNI-PFBS, manufactured by Toyo Gosei Co., Ltd.) and 1 part of Kayacure-DETX-S (manufactured by Nippon Kayaku Co., Ltd.) were then added to obtain a curable liquid developer 1.

The average particle size (D50) on a volume basis of the toner particle contained in the resulting curable liquid developer 1 was 0.7 μm.

Manufacturing Example of Curable Liquid Developer 2

| | | |
|---|---|---|
| Copper phthalocyanine pigment 2 | 10 | parts |
| Pigment-dispersed resin | 10 | parts |
| Tetrahydrofuran | 80 | parts |

A pigment-dispersed slurry 2 was obtained as in the manufacturing example of the curable liquid developer 1 except that the above formulation was used.

| | | |
|---|---|---|
| Pigment-dispersed slurry 2 | 60 | parts |
| Binder resin 2 solution | 80 | parts |
| Toner particle dispersing agent | 8 | parts |
| (Solsperse 13940, basic, manufactured | | |
| by Lubrizol Japan) | | |

A curable liquid developer 2 was then obtained as in the manufacturing example of the curable liquid developer 1 except that the above formulation was used.

The average particle size (D50) on a volume basis of the toner particle contained in the resulting curable liquid developer 2 was 0.8 μm.

Manufacturing Example of Curable Liquid Developer 3

| | | |
|---|---|---|
| Copper phthalocyanine pigment 3 | 10 | parts |
| Pigment-dispersed resin | 10 | parts |
| Tetrahydrofuran | 80 | parts |

A pigment-dispersed slurry 3 was obtained as in the manufacturing example of curable liquid developer 1 except that the above formulation was used.

| | | |
|---|---|---|
| Pigment-dispersed slurry 3 | 60 | parts |
| Binder resin 1 solution | 80 | parts |
| Toner particle dispersing agent | 12 | parts |
| (Ajisper PB-817, basic, manufactured by | | |
| Ajinomoto Fine-Techno Co. , Inc.) | | |

A curable liquid developer 3 was then obtained as in the manufacturing example of the curable liquid developer 1 except that the above formulation was used.

The average particle size (D50) on a volume basis of the toner particle contained in the resulting curable liquid developer 3 was 0.8 μm.

Manufacturing Example of Curable Liquid Developer 4

| | | |
|---|---|---|
| Pigment-dispersed slurry 1 | 60 | parts |
| Binder resin 3 solution | 80 | parts |
| Toner particle dispersing agent | 12 | parts |
| (Ajisper PB-817, basic, manufactured by | | |
| Ajinomoto Fine-Techno Co. , Inc.) | | |

A curable liquid developer 4 was obtained as in the manufacturing example of the curable liquid developer 1 except that the above formulation was used.

The average particle size (D50) on a volume basis of the toner particle contained in the resulting curable liquid developer 4 was 1.5 μm.

Manufacturing Example of Curable Liquid Developer 5

| | | |
|---|---|---|
| Copper phthalocyanine pigment 1 | 6 | parts |
| Pigment-dispersed resin | 6 | parts |
| Binder resin 1 | 80 | parts |

These materials were thoroughly mixed in a Henschel mixer, and then melt kneaded using a co-rotating twin screw extruder having an in-roll heating temperature of 100° C. to obtain a melt kneaded product.

The resulting melt kneaded product was cooled, coarsely pulverized and then wet classified to obtain a toner particle.

Next, 40 parts of 2-butyl-2-ethyl-1,3-propanediol divinyl ether (Example Compound B-27), 20 parts of the toner particle and 2.8 parts of a toner particle dispersing agent (Ajisper PB-817, basic, manufactured by Ajinomoto Fine-Techno Co., Inc.) were mixed for 24 hours with a sand mill to obtain a toner particle dispersion 5.

The resulting toner particle dispersion 5 (10 parts) was centrifuged, the supernatant was removed by decantation, new 2-butyl-2-ethyl-1,3-propanediol divinyl ether was added in the same mass amount as the removed supernatant, and the particle was re-dispersed.

0.10 parts of hydrogenated lecithin (product name: Lecinol S-10, manufactured by Nikko Chemicals Co., Ltd.), 90 parts of 2-butyl-2-ethyl-1,3-propanediol divinyl ether (Example Compound B-27), 0.30 parts of a photopolymerization initiator (product name: NHNI-PFBS, manufactured by Toyo Gosei Co., Ltd.) and 1 part of Kayacure-DETX-S (manufactured by Nippon Kayaku Co., Ltd.) were then added to obtain a curable liquid developer 5.

The average particle size (D50) on a volume basis of the toner particle contained in the resulting curable liquid developer 5 was 2.5 μm.

Manufacturing Example of Curable Liquid Developer 6

| | | |
|---|---|---|
| Pigment-dispersed slurry 1 | 60 | parts |
| Binder resin 1 solution | 80 | parts |
| Toner particle dispersing agent | 12 | parts |
| (Ajisper PN-411, neutral, Ajinomoto | | |
| Fine-Techno Co. , Inc.) | | |

A curable liquid developer 6 was obtained as in the manufacturing example of the curable liquid developer 1 except that the above formulation was used.

The average particle size (D50) on a volume basis of the toner particle contained in the resulting curable liquid developer 6 was 2.5 μm.

Manufacturing Example of Curable Liquid Developer 7

| | | |
|---|---|---|
| Pigment-dispersed slurry 1 | 60 | parts |
| Binder resin 4 solution | 80 | parts |
| Toner particle dispersing agent | 12 | parts |
| (Ajisper PB-817, basic, manufactured by | | |
| Ajinomoto Fine-Techno Co. , Inc.) | | |

A curable liquid developer 7 was obtained as in the manufacturing example of the curable liquid developer 1 except that the above formulation was used.

The average particle size (D50) on a volume basis of the toner particle contained in the resulting curable liquid developer 7 was 2.7 μm.

Manufacturing Example of Curable Liquid Developer 8

| | | |
|---|---|---|
| Copper phthalocyanine pigment 4 | 10 | parts |
| Pigment-dispersed resin | 10 | parts |
| Tetrahydrofuran | 80 | parts |

A pigment-dispersed slurry 4 was obtained as in the manufacturing example of the curable liquid developer 1 except that the above formulation was used.

| | |
|---|---|
| Pigment-dispersed slurry 4 | 60 parts |
| Binder resin 1 solution | 80 parts |
| Toner particle dispersing agent | 12 parts |
| (Ajisper PB-817, basic, manufactured by | |
| Ajinomoto Fine-Techno Co., Inc.) | |

A curable liquid developer 8 was then obtained as in the manufacturing example of the curable liquid developer 1 except that the above formulation was used.

The average particle size (D50) on a volume basis of the toner particle contained in the resulting curable liquid developer 8 was 0.7 μm.

Manufacturing Example of Curable Liquid Developer 9

| | |
|---|---|
| Copper phthalocyanine pigment 5 | 10 parts |
| Pigment-dispersed resin | 10 parts |
| Tetrahydrofuran | 80 parts |

A pigment-dispersed slurry 5 was obtained as in the manufacturing example of the curable liquid developer 1 except that the above formulation was used.

| | |
|---|---|
| Pigment-dispersed slurry 5 | 60 parts |
| Binder resin 1 solution | 80 parts |
| Toner particle dispersing agent | 12 parts |
| (Ajisper PB-817, basic, manufactured by | |
| Ajinomoto Fine-Techno Co., Inc.) | |

A curable liquid developer 9 was then obtained as in the manufacturing example of the curable liquid developer 1 except that the above formulation was used.

The average particle size (D50) on a volume basis of the toner particle contained in the resulting curable liquid developer 9 was 0.8 μm.

Manufacturing Example of Curable Liquid Developer 10

| | |
|---|---|
| Copper phthalocyanine pigment 6 | 10 parts |
| Pigment-dispersed resin | 10 parts |
| Tetrahydrofuran | 80 parts |

A pigment-dispersed slurry 6 was obtained as in the manufacturing example of curable liquid developer 1 except that the above formulation was used.

| | |
|---|---|
| Pigment-dispersed slurry 6 | 60 parts |
| Binder resin 1 solution | 80 parts |
| Toner particle dispersing agent | 12 parts |
| (Ajisper PB-817, basic, manufactured by | |
| Ajinomoto Fine-Techno Co., Inc.) | |

A curable liquid developer 10 was then obtained as in the manufacturing example of the curable liquid developer 1 except that the above formulation was used.

The average particle size (D50) on a volume basis of the toner particle contained in the resulting curable liquid developer 10 was 0.8 μm.

Manufacturing Example of Curable Liquid Developer 11

| | |
|---|---|
| Copper phthalocyanine pigment 7 | 10 parts |
| Pigment-dispersed resin | 10 parts |
| Tetrahydrofuran | 80 parts |

A pigment-dispersed slurry 7 was obtained as in the manufacturing example of curable liquid developer 1 except that the above formulation was used.

| | |
|---|---|
| Pigment-dispersed slurry 7 | 60 parts |
| Binder resin 1 solution | 80 parts |
| Toner particle dispersing agent | 12 parts |
| (Ajisper PB-817, basic, manufactured by | |
| Ajinomoto Fine-Techno Co., Inc.) | |

A curable liquid developer 11 was then obtained as in the manufacturing example of the curable liquid developer 1 except that the above formulation was used.

The average particle size (D50) on a volume basis of the toner particle contained in the resulting curable liquid developer 11 was 0.8 μm.

Manufacturing Example of Curable Liquid Developer 12

| | |
|---|---|
| Copper phthalocyanine pigment 8 | 10 parts |
| Pigment-dispersed resin | 10 parts |
| Tetrahydrofuran | 80 parts |

A pigment-dispersed slurry 8 was obtained as in the manufacturing example of the curable liquid developer 1 except that the above formulation was used.

| | |
|---|---|
| Pigment-dispersed slurry 8 | 60 parts |
| Binder resin 1 solution | 80 parts |
| Toner particle dispersing agent | 12 parts |
| (Ajisper PB-817, basic, manufactured by | |
| Ajinomoto Fine-Techno Co., Inc.) | |

A curable liquid developer 12 was then obtained as in the manufacturing example of the curable liquid developer 1 except that the above formulation was used.

The average particle size (D50) on a volume basis of the toner particle contained in the resulting curable liquid developer 12 was 0.8 μm.

Manufacturing Example of Curable Liquid Developer 13

| | |
|---|---|
| Copper phthalocyanine pigment 9 | 10 parts |
| Pigment-dispersed resin | 10 parts |
| Tetrahydrofuran | 80 parts |

A pigment-dispersed slurry 9 was obtained as in the manufacturing example of curable liquid developer 1 except that the above formulation was used.

| | |
|---|---|
| Pigment-dispersed slurry 9 | 60 parts |
| Binder resin 1 solution | 80 parts |
| Toner particle dispersing agent | 12 parts |
| (Ajisper PB-817, basic, manufactured by | |
| Ajinomoto Fine-Techno Co., Inc.) | |

A curable liquid developer 13 was then obtained as in the manufacturing example of the curable liquid developer 1 except that the above formulation was used.

The average particle size (D50) on a volume basis of the toner particle contained in the resulting curable liquid developer 13 was 0.8 μm.

Manufacturing Example of Curable Liquid Developer 14

| | |
|---|---|
| Copper phthalocyanine pigment 10 | 10 parts |
| Pigment-dispersed resin | 10 parts |
| Tetrahydrofuran | 80 parts |

A pigment-dispersed slurry 10 was obtained as in the manufacturing example of curable liquid developer 1 except that the above formulation was used.

| | |
|---|---|
| Pigment-dispersed slurry 10 | 60 parts |
| Binder resin 1 solution | 80 parts |
| Toner particle dispersing agent | 12 parts |
| (Ajisper PB-817, basic, manufactured by | |
| Ajinomoto Fine-Techno Co., Inc.) | |

A curable liquid developer 14 was then obtained as in the manufacturing example of the curable liquid developer 1 except that the above formulation was used.

The average particle size (D50) on a volume basis of the toner particle contained in the resulting curable liquid developer 14 was 0.8 μm.

Manufacturing Example of Curable Liquid Developer 15

| | |
|---|---|
| Copper phthalocyanine pigment 11 | 10 parts |
| Pigment-dispersed resin | 10 parts |
| Tetrahydrofuran | 80 parts |

A pigment-dispersed slurry 11 was obtained as in the manufacturing example of curable liquid developer 1 except that the above formulation was used.

| | |
|---|---|
| Pigment-dispersed slurry 11 | 60 parts |
| Binder resin 1 solution | 80 parts |
| Toner particle dispersing agent | 12 parts |
| (Ajisper PB-817, basic, manufactured by | |
| Ajinomoto Fine-Techno Co., Inc.) | |

A curable liquid developer 15 was then obtained as in the manufacturing example of the curable liquid developer 1 except that the above formulation was used.

The average particle size (D50) on a volume basis of the toner particle contained in the resulting curable liquid developer 15 was 0.8 μm.

### Example 1

Fixing performance and dark polymerizability were evaluated by the following methods and standards using the curable liquid developer 1. Results are shown in Table 1.

Evaluation of Fixing Performance

At 25° C., the curable liquid developer was coated (to a thickness of 8.0 μm) with a wire bar (No. 6) onto a polyethylene terephthalate film, and exposed to UV light from a high-pressure mercury lamp with a lamp output of 120 mW/cm² to form a cured film.

Immediately after being cured, the surface of the film was touched with a finger to confirm the presence or absence of surface tackiness (stickiness), which was evaluated according to the following standard.

3: No tackiness detected after curing with 75 mJ/cm² of light

2: Some tackiness detected after curing with 75 mJ/cm² of light, but no tackiness detected after curing with 300 mJ/cm² of light

1: Tackiness detected after exposure to 300 mJ/cm² of light

Evaluation of Dark Polymerizability

5 g of the curable liquid developer was placed in a light-shielded glass bottle with a screw cap and placed in a 50° C. thermostatic tank set in a dark place, and the days taken for the curable developer to cure were evaluated.

A: No curing after at least 120 days

B: Cured in at least 60 and less than 120 days

C: Cured in at least 30 and less than 60 days

D: Cured in less than 30 days

### Examples 2 to 13 and Comparative Examples 1 to 2

Fixing performance and dark polymerizability were evaluated as in Example 1 except that the curable liquid developers 2 to 15 were used. The results are shown in Table 1.

When the curable liquid developer 1 was evaluated, the fixing performance was rated as 2 (no problems for practical use), and dark polymerizability was rated as A, with no curing occurring after at least 120 days.

When the curable liquid developer 2 was evaluated, the fixing performance was excellent (evaluated as 3), and dark polymerizability was rated as A, with no curing occurring after at least 120 days.

When the curable liquid developer 3 was evaluated, the fixing performance was the same as in Example 1, and although curing occurred after 110 days in the dark polymerizability evaluation, this was not a problem for practical use.

When the curable liquid developer 4 was evaluated, the fixing performance was the same as in Example 1, and although curing occurred after 70 days in the dark polymerizability evaluation, this was not a problem for practical use.

When the curable liquid developer 5 was evaluated, the fixing performance was the same as in Example 1, and although curing occurred after 56 days in the dark polymerizability evaluation, this was not a problem for practical use.

When the curable liquid developer 6 was evaluated, the fixing performance was the same as in Example 1, and although curing occurred after 54 days in the dark polymerizability evaluation, this was not a problem for practical use.

When the curable liquid developer 7 was evaluated, the fixing performance was the same as in Example 1, and although curing occurred after 52 days in the dark polymerizability evaluation, this was not a problem for practical use.

When the curable liquid developer 8 was evaluated, the fixing performance was the same as in Example 1, but curing occurred after 25 days in the evaluation of dark polymerizability, a result that was clearly inferior to those of the examples.

When the curable liquid developer 9 was evaluated, the fixing performance was the same as in Example 1, but curing occurred after 10 days in the evaluation of dark polymerizability, a result that was dramatically inferior to those of the examples.

When the curable liquid developer 10 was evaluated, the fixing performance was rated as 2 (no problems for practical use), and dark polymerizability was rated as A, with no curing occurring after at least 120 days.

When the curable liquid developer 11 was evaluated, the fixing performance was rated as 2 (no problems for practical use), and dark polymerizability was rated as A, with no curing occurring after at least 120 days.

When the curable liquid developer 12 was evaluated, the fixing performance was rated as 2 (no problems for practical use), and dark polymerizability was rated as A, with no curing occurring after at least 120 days.

When the curable liquid developer 13 was evaluated, the fixing performance was rated as 2 (no problems for practical use), and dark polymerizability was rated as A, with no curing occurring after at least 120 days.

When the curable liquid developer 14 was evaluated, the fixing performance was rated as 2 (no problems for practical use), and dark polymerizability was rated as A, with no curing occurring after at least 120 days.

When the curable liquid developer 15 was evaluated, the fixing performance was rated as 2 (no problems for practical use), and dark polymerizability was rated as A, with no curing occurring after at least 120 days.

TABLE 1

| | Curable | Copper | | Binder | Toner particle | | |
|---|---|---|---|---|---|---|---|
| | liquid | phthalocyanine | Binder | resin acid | dispersing | Fixing | Dark |
| | developer | pigment | resin | value | agent | performance | polymerizability |
| | No. | No. | No. | (mg KOH/g) | No. | evaluation | evaluation |
| Example 1 | 1 | 1 | 1 | 10 | (1) | 2 | A |
| Example 2 | 2 | 2 | 2 | 15 | (2) | 3 | A |
| Example 3 | 3 | 3 | 1 | 10 | (1) | 2 | B |
| Example 4 | 4 | 1 | 3 | 8 | (1) | 2 | B |
| Example 5 | 5 | 1 | 1 | 10 | (1) | 2 | C |
| Example 6 | 6 | 1 | 1 | 10 | (3) | 2 | C |
| Example 7 | 7 | 1 | 4 | 7 | (1) | 2 | C |
| Comparative | 8 | 4 | 1 | 10 | (1) | 2 | D |
| Example 1 | | | | | | | |
| Comparative | 9 | 5 | 1 | 10 | (1) | 2 | D |
| Example 2 | | | | | | | |
| Example 8 | 10 | 6 | 1 | 10 | (1) | 2 | A |
| Example 9 | 11 | 7 | 1 | 10 | (1) | 2 | A |
| Example 10 | 12 | 8 | 1 | 10 | (1) | 2 | A |
| Example 11 | 13 | 9 | 1 | 10 | (1) | 2 | A |
| Example 12 | 14 | 10 | 1 | 10 | (1) | 2 | A |
| Example 13 | 15 | 11 | 1 | 10 | (1) | 2 | A |

Each toner particle dispersing agent No. in Table 1 represents the following:
(1) Ajisper PB-817 (basic by Ajinomoto Fine-Techno Co., Inc.)
(2) Solsperse 13940 (basic by Lubrizol Japan)
(3) Ajisper PN-411 (neutral by Ajinomoto Fine-Techno Co., Inc.).

With the present invention, it is possible to provide a curable liquid developer whereby dark polymerization reactions are suppressed even when the developer contains a copper phthalocyanine pigment, along with a method for manufacturing the curable liquid developer.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-094850, filed, May 11, 2017, and Japanese Patent Application No. 2018-018692, filed, Feb. 5, 2018, which are hereby incorporated by reference herein in their entirety.

What is claimed is:

1. A curable liquid developer comprising:
a toner particle containing a binder resin and a pigment;
a toner particle dispersing agent; and
a cationically polymerizable liquid monomer that does not dissolve the binder resin,
the pigment containing a copper phthalocyanine derivative represented by formula (1) below: 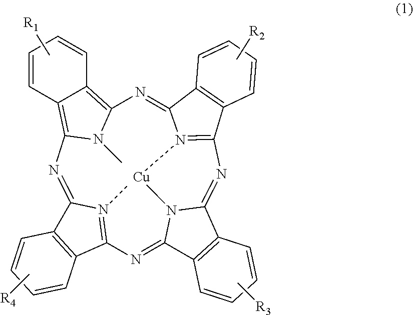
in formula (1), each of R₁, R₂, R₃ and R₄ individually represents a hydrogen atom or a substituent derived from an amine compound, and at least one of R₁, R₂, R₃ and R₄ represents a substituent derived from an amine compound.

2. The curable liquid developer according to claim 1, wherein at least one of the R₁, R₂, R₃ and R₄ is formula (A), (B), (C), (D), (E), (F), (G) or (H) below: 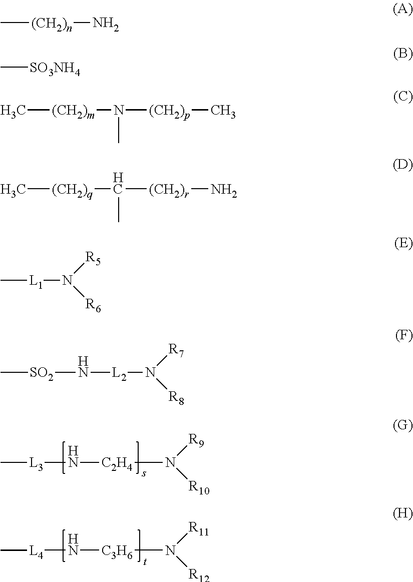
in formula (A), n is an integer of at least 0 and not more than 10, in formula (C), each of m and p is independently an integer of at least 0 and not more than 10, in formula (D), each of q and r is independently an integer of at least 0 and not more than 10, and
in formulae (E), (F), (G) and (H), each of L₁, L₂, L₃ and L₄ is independently a C₁₋₄ linear or branched saturated alkylene group, each of R₅, R₆, R₇, R₈, R₉, R₁₀, R₁₁ and R₁₂ is independently a hydrogen atom or C₁₋₄ linear or branched saturated alkyl group, and each of s and t is independently an integer of at least 1 and not more than 5.

3. The curable liquid developer according to claim 1, wherein a content of the copper phthalocyanine derivative represented by formula (1) in the pigment is at least 1 mass % and not more than 50 mass %.

4. The curable liquid developer according to claim 1, wherein an acid value of the binder resin is at least 8 mg KOH/g and not more than 40 mg KOH/g.

5. The curable liquid developer according to claim 1, wherein the toner particle dispersing agent is basic.

6. A method for manufacturing a curable liquid developer comprising a toner particle containing a binder resin and a pigment, a toner particle dispersing agent, and a cationically polymerizable liquid monomer that does not dissolve the binder resin,
the method comprising:
preparing a pigment-dispersed solution containing the binder resin, the pigment, the toner particle dispersing agent and a solvent that dissolves the binder resin;
preparing a liquid mixture containing the pigment-dispersed solution and the cationically polymerizable liquid monomer; and
removing the solvent from the liquid mixture,
the pigment containing a copper phthalocyanine derivative represented by formula (1) below: 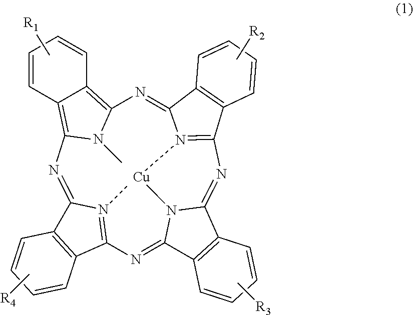
in formula (1), each of R₁, R₂, R₃ and R₄ individually represents a hydrogen atom or a substituent derived from an amine compound, and at least one of R₁, R₂, R₃ and R₄ represents a substituent derived from an amine compound.

7. The method for manufacturing a curable liquid developer according to claim 6, wherein at least one of the R₁, R₂, R₃ and R₄ is formula (A), (B), (C), (D), (E), (F), (G) or (H) below: 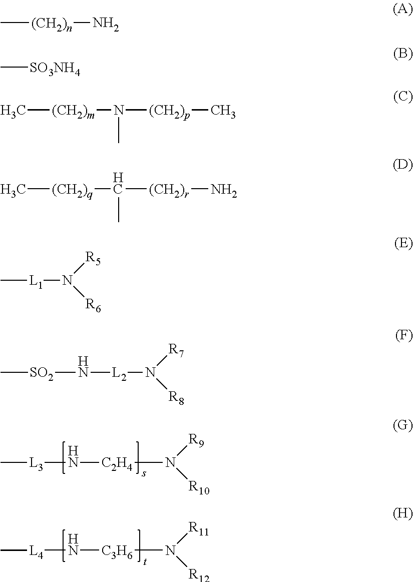
in formula (A), n is an integer of at least 0 and not more than 10, in formula (C), each of m and p is independently an integer of at least 0 and not more than 10, in formula (D) each of q and r is independently an integer of at least 0 and not more than 10, and
in formulae (E), (F), (G) and (H), each of L₁, L₂, L₃ and L₄ is independently a C₁₋₄ linear or branched saturated alkylene group, each of R₅, R₆, R₇, R₈, R₉, R₁₀, R₁₁ and R₁₂ is independently a hydrogen atom or C₁₋₄ linear or branched saturated alkyl group, and each of s and t is independently an integer of at least 1 and not more than 5.

8. The method for manufacturing a curable liquid developer according to claim 6, wherein a content of the copper phthalocyanine derivative represented by formula (1) in the pigment is at least 1 mass % and not more than 50 mass %.

9. The method for manufacturing a curable liquid developer according to claim 6, wherein an acid value of the binder resin is at least 8 mg KOH/g and not more than 40 mg KOH/g.

10. The method for manufacturing a curable liquid developer according to claim 6, wherein the toner particle dispersing agent is basic.

11. A method for manufacturing a curable liquid developer comprising a toner particle containing a binder resin and a pigment, a toner particle dispersing agent, and a cationically polymerizable liquid monomer that does not dissolve the binder resin,
the method comprising:
preparing a pigment-dispersed solution containing the binder resin, the pigment, the toner particle dispersing agent and a first solvent dissolving the binder resin;
preparing a first liquid mixture containing the pigment-dispersed solution and a second solvent not dissolving the binder resin, the second solvent being other than the cationically polymerizable liquid monomer;
preparing a toner particle dispersion by removing the first solvent dissolving the binder resin from the first liquid mixture; and
preparing a second liquid mixture containing the toner particle dispersion and the cationically polymerizable liquid monomer,
the pigment containing a copper phthalocyanine derivative represented by formula (1) below: 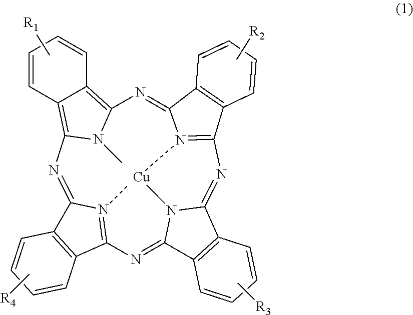
in formula (1), each of R₁, R₂, R₃ and R₄ individually represents a hydrogen atom or a substituent derived from an amine compound, and at least one of R₁, R₂, R₃ and R₄ represents a substituent derived from an amine compound.
